(19) United States
(12) Patent Application Publication
(10) Pub. No.: US 2009/0195940 A1
(43) Pub. Date: Aug. 6, 2009

(54) MAGNETIC HEAD AND MULTILAYERED CIRCUIT

(75) Inventors: Junji Sato, Kawasaki (JP); Takashi Ito, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/245,301

(22) Filed: Oct. 3, 2008

(30) Foreign Application Priority Data
Feb. 1, 2008 (JP) 2008-023201

(51) Int. Cl. G11B 5/33

(52) U.S. Cl. 360/319; G9B/5.104

(57) ABSTRACT

In the magnetic head, terminal sections for mutually electrically connecting layers in the multilayer structure can be formed without forming raising layers. The magnetic head having a multilayer structure comprises: an upper shielding layer; a lower shielding layer; a magnetoresistance effect element section provided between the shielding layers; a magnetic pole; terminal sections mutually electrically connecting layers of the multilayer structure; and a first low-thermal expansion material layer composed of an insulating material, and each of the terminal sections has a multilayer structure comprising: a second low-thermal expansion material layer composed of a material which is the same as that of the first low-thermal expansion material layer; and a plurality of electrically conductive layers.

### BACKGROUND OF THE INVENTION

The present invention relates to a magnetic head and a multilayered circuit, more precisely relates to a magnetic head and a multilayered circuit, each of which has a low-thermal expansion material layer or an insulating layer for preventing a projecting phenomenon caused by environmental temperature.

These days, memory capacities of storing units, e.g., magnetic disk unit, have been significantly increased. Thus, improving performance of storage media and improving reading and reproducing characteristics of magnetic heads are required. Magnetic heads including magnetoresistance effect (MR) elements, e.g., giant magnetoresistance (GMR) element capable of obtaining a high output power, tunneling magnetoresistance (TMR) element capable of obtaining high reproduction sensitivity, have been developed. On the other hand, induction type recording heads using electromagnetic induction have been developed. For example, a composite type thin film magnetic head, in which the above described reproducing head and recording head are combined, is now used.

To improve recording density of a magnetic disk unit, signal-to-noise ratio (S/N ratio) of reproducing signals of a magnetoresistance effect reproducing element must be highly increased by reducing an amount of floating a magnetic head from a magnetic storage medium. However, in case of using the magnetic disk unit in a hot environment, projecting an air bearing surface of the thin film magnetic head becomes something of a problem by reducing the amount of floating the magnetic head from the surface of the magnetic storage medium. The reason of causing the problem is that metallic parts and organic matters, e.g., resist, of the magnetic head, whose thermal expansion coefficients are great, are expanded in the hot environment, but they are not projected from a substrate, which is composed of, for example, Al₂O₃ having small thermal expansion coefficient, but they are projected from the air bearing surface. If the projection is significant, an end of the magnetic head contacts the magnetic storage medium whereby the magnetic head and/or the magnetic storage medium will be damaged. In an actual magnetic disk unit, the amount of floating the magnetic head is great so as not to cause the contact in the hot environment. However, recording and reproducing characteristics of the magnetic head will be worsened at the room temperature or in a cool environment, and recording density cannot be increased. Therefore, the projection must be prevented so as to highly increase the recording density of the magnetic disk unit.

A conventional magnetic head capable of solving the problem of the projecting phenomenon of the air bearing surface, which is caused by environment temperature, is disclosed in Japanese Laid-open Patent Publication No. 2004-334995. In the magnetic head, at least one of a lower shielding layer and an upper shielding layer is composed of a magnetic material having small thermal expansion coefficient, and at least one of them is formed by a laminated film, which is constituted by the magnetic material having small thermal expansion coefficient and NiFe so as to reduce recording noises and restrain the projecting phenomenon.

A magnetic head having a low-thermal expansion material layer composed of an insulating material, which has been studied by the inventors, is shown in FIGS. 17A and 17B.

Generally, in the magnetic head 101, a lower magnetic pole (return yoke) layer 119 must be flat, so a part of the lower magnetic pole layer 119 exposed in a wafer surface 107 must be substantially level with the wafer surface 107. In case of forming a low-thermal expansion layer 118 under the lower magnetic pole layer 119, but no low-thermal expansion layers are formed in terminal sections 103, which electrically connects layers. Therefore, non-exposed layers 129, which are not exposed in the wafer surface 107 after completing a flattening process, are formed. To solve this problem, raising layers 120 are further formed on the non-exposed layers 129 and extended in a direction perpendicular to a layering direction, so that the wafer surface 107 can be flattened. However, by adding the step of forming the raising layers 120, number of the production steps must be increased. Note that, the raising layers 120 are electrically conductive layers. In case that the magnetic head 101 has a multilayer structure, the raising layers 120 electrically connect layers in the multilayer structure and act as wiring patterns for exposing the terminal sections 103 in the wafer surface 107.

### SUMMARY OF THE INVENTION

The present invention was conceived to solve the above described problem.

An object of the present invention is to provide a suitable magnetic head, which has a low-thermal expansion material layer as an inner layer of a multilayer structure and in which terminal sections for mutually electrically connecting layers in the multilayer structure can be formed without forming raising layers.

Another object is to provide a multilayered circuit, which has an insulating layer as an inner layer of a multilayer structure and in which terminal sections for mutually electrically connecting layers in the multilayer structure can be formed without forming raising layers.

To achieve the objects, the present invention has following constitutions.

Namely, a magnetic head having a multilayer structure comprises: an upper shielding layer; a lower shielding layer; a magnetoresistance effect element section being provided between the upper shielding layer and the lower shielding layer as an inner layer of the multilayer structure; a magnetic pole; terminal sections mutually electrically connecting layers of the multilayer structure; and a first low-thermal expansion material layer composed of an insulating material, and each of the terminal sections has a multilayer structure including: a second low-thermal expansion material layer composed of a material which is the same as that of the first low-thermal expansion material layer; and a plurality of electrically conductive layers including first conductive layers and second conductive layers.

In the magnetic head, the second low-thermal expansion material layer of each of the terminal sections may coat a part of each of the first conductive layers, and each of the second conductive layers may coat a part of the second low-thermal expansion material layer of each of the terminal sections and a part of each of the first conductive layers.

In the magnetic head, a lower surface area of the second low-thermal expansion material layer of each of the terminal sections may be smaller than an upper surface area of the first conductive layer of each of the terminal sections.

In the magnetic head, an upper end part of the second low-thermal expansion material layer of each of the terminal sections may be formed into a tapered shape.

Another magnetic head having a multilayer structure comprises: an upper shielding layer; a lower shielding layer; a magnetoresistance effect element section being provided between the upper shielding layer and the lower shielding layer as an inner layer of the multilayer structure; a magnetic pole; terminal sections mutually electrically connecting layers of the multilayer structure; and a low-thermal expansion material layer, the low-thermal expansion material layer is composed of an electrically conductive material, and each of the terminal sections has a multilayer structure including: a layer composed of a material which is the same as that of the low-thermal expansion material layer; and an electrically conductive layer.

Further, a multilayered circuit having a multilayer structure comprises: an element section which is an inner layer of the multilayer structure; terminal sections mutually electrically connecting layers of the multilayer structure; and a first insulating layer, each of the terminal sections has a multilayer structure including: a second insulating layer composed of a material which is the same as that of the first insulating layer; and a plurality of electrically conductive layers including first conductive layers and second conductive layers, the second insulating layer of each of the terminal sections coats a part of each of the first conductive layers, and each of the second conductive layers coats a part of the second insulating layer of each of the terminal sections and a part of each of the first conductive layers.

In the multilayered circuit, a lower surface area of the second insulating layer of each of the terminal sections may be smaller than an upper surface area of the first conductive layer of each of the terminal sections.

In the multilayered circuit, an upper end part of the second insulating layer of each of the terminal sections may be formed into a tapered shape.

In the present invention, the terminal sections for mutually electrically connecting the layers in the multilayer structure can be formed, without forming raising layers, in the magnetic head including the low-thermal expansion material layer capable of preventing the projecting phenomenon or in the multilayered circuit including the insulating layer capable of preventing the projecting phenomenon.

In each of the terminal sections, the first conductive layer, which is formed under the second low-thermal expansion material layer composed of the insulating material, can be electrically connected to the second conductive layer, which is formed on the second low-thermal expansion material layer.

Further, in each of the terminal sections, by forming the upper end part of the second low-thermal expansion material layer or the second insulating layer into the tapered shape, the conductive layer can be stably formed on the low-thermal expansion material layer.

### BRIEF DESCRIPTION OF THE DRAWINGS

Embodiments of the present invention will now be described by way of examples and with reference to the accompanying drawings, in which:

FIGS. 1A and 1B are schematic views of a magnetic head of a first embodiment of the present invention;

FIGS. 2A and 2B are schematic views of a modified example of the magnetic head shown in FIGS. 1A and 1B;

FIGS. 3A and 3B are schematic views of another modified example of the magnetic head shown in FIGS. 1A and 1B;

FIGS. 4A and 4B are schematic views of a magnetic head of a second embodiment of the present invention;

FIGS. 5A and 5B are schematic views of a magnetic head of a third embodiment of the present invention;

FIGS. 6A and 6B are schematic views of a magnetic head of a fourth embodiment of the present invention;

FIGS. 7A and 7B are schematic views of a magnetic head of a fifth embodiment of the present invention;

FIGS. 8A and 8B are schematic views of a magnetic head of a sixth embodiment of the present invention;

FIGS. 9A and 9B are schematic views of a magnetic head of a seventh embodiment of the present invention;

FIGS. 10A and 10B are schematic views of a magnetic head of an eighth embodiment of the present invention;

FIGS. 11A and 11B are schematic views of a magnetic head of a ninth embodiment of the present invention;

FIGS. 12A and 12B are schematic views of a magnetic head of a tenth embodiment of the present invention;

FIGS. 13A and 13B are schematic views of a magnetic head of an eleventh embodiment of the present invention;

FIGS. 14A and 14B are schematic views of a magnetic head of a twelfth embodiment of the present invention;

FIGS. 15A and 15B are schematic views of a magnetic head of a thirteenth embodiment of the present invention;

FIGS. 16A and 16B are schematic views of a magnetic head of a fourteenth embodiment of the present invention; and

FIGS. 17A and 17B are schematic views of the conventional magnetic head.

### DETAILED DESCRIPTION OF THE EMBODIMENTS

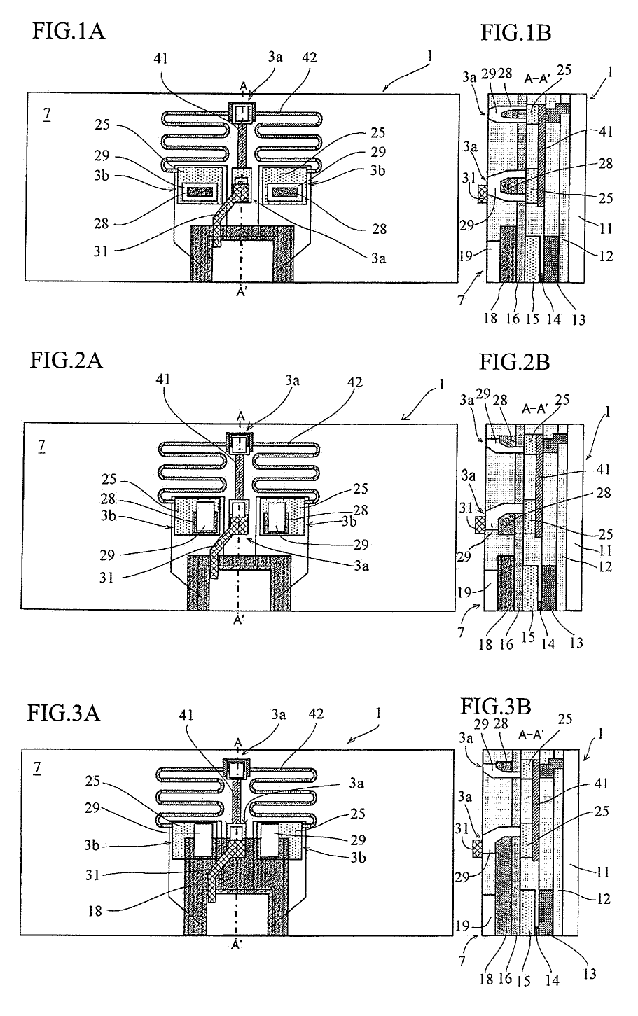

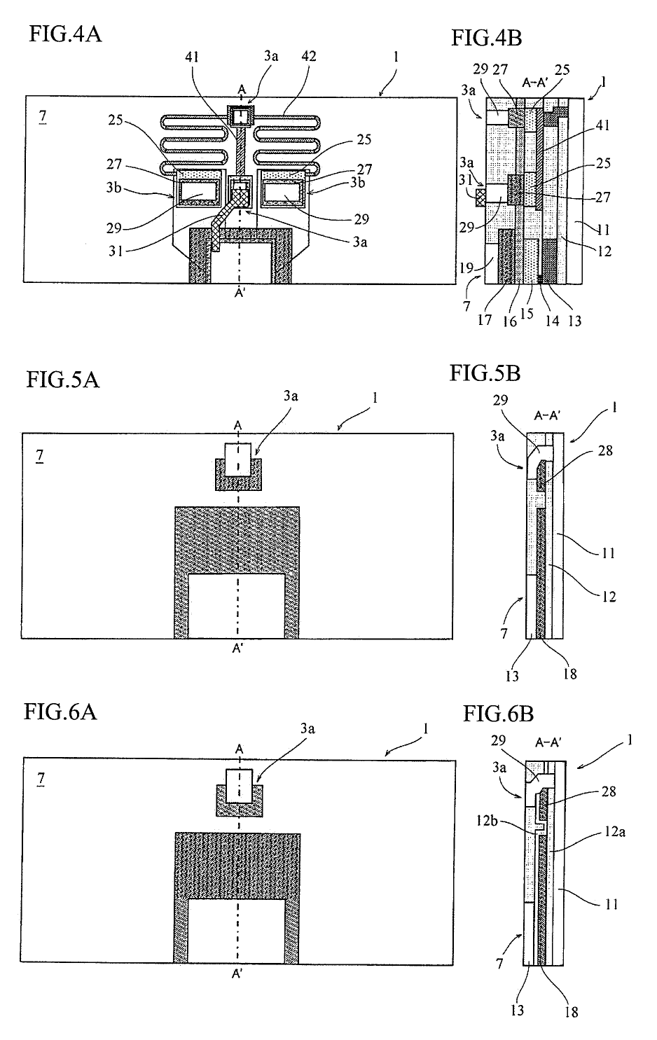

Preferred embodiments of the present invention will now be described in detail with reference to the accompanying drawings, in which: FIGS. 1A and 1B are schematic views of a magnetic head of a first embodiment of the present invention. FIG. 1A is a schematic plan view, in which layers other than an outermost layer are indicated by solid lines for clarify their places, and FIG. 1B is a schematic sectional view. Note that, in each of other drawings, A is a schematic plan view and B is a schematic sectional view as well as FIGS. 1A and 1B. FIGS. 2A and 2B are schematic views of a modified example of the magnetic head shown in FIGS. 1A and 1B. FIGS. 3A and 3B are schematic views of another modified example of the magnetic head shown in FIGS. 1A and 1B. FIGS. 4A and 4B are schematic views of a magnetic head of a second embodiment of the present invention. FIGS. 5A-9B are schematic views of magnetic heads of other embodiments, in each of which a first low-thermal expansion material layer 18 composed of an insulating material is formed. FIGS. 10A-16B are schematic views of magnetic heads of further embodiments, in each of which a low-thermal expansion material layer composed of an electrically conductive material is formed.

### FIRST EMBODIMENT

A magnetic head 1 of a first embodiment will be explained.

The magnetic head 1 comprises: a magnetoresistance effect element section being provided between an upper shielding layer and a lower shielding layer as an inner layer of a multilayer structure; a magnetic pole; terminal sections mutually electrically connecting layers of the multilayer structure; and a first low-thermal expansion material layer composed of an insulating material. Namely, as shown in FIGS. 1A and 1B, an undercoat film 12, the lower shielding layer 13, the magnetoresistance effect element section 14, the upper shielding layer 15, a magnetism separation layer 16, the first low-thermal expansion material layer 18 composed of the insulating material and a lower magnetic pole (return yoke) 19 are layered on a substrate 11.

For example, the substrate 11 is composed of Al₂O₃—TiC. The undercoat film 12 on the substrate 11 is composed of Al₂O₃. Note that, in the drawings, parts indicated by the same hatching are composed of the same material. The materials of them are not limited to the present embodiment.

The magnetoresistance effect element section 14 is formed between the lower shielding layer 13 and the upper shielding layer 15. The magnetoresistance effect element section 14 includes a reproducing element, e.g., TMR element, GMR element. TMR elements and GNR elements having various types of film structures may be used as the reproducing element.

In the present embodiment, a current perpendicular to plane-GMR (CPP-GMR) element or a current in plane-GMR (CIP-GMR) element is used.

Note that, the lower shielding layer 13 is composed of a soft magnetic material, e.g., NiFe, and formed by plating, sputtering, etc. The upper shielding layer 15 is also composed of a soft magnetic material, e.g., NiFe, as well as the lower shielding layer 13.

In case that the TMR element or the CPP-GMR element is included in the magnetoresistance effect element section 14, the shielding layers 13 and 15 act as electrodes of the element.

In the case that the CIP-GMR element is included in the magnetoresistance effect element section 14, an electric current passes in the plane direction of the element, so the shielding layers 13 and 15 do not act as electrodes of the element.

The magnetism separation layer 16 is composed of Al₂O₃, but the material is not limited.

In the present embodiment, the first low-thermal expansion material layer 18 is formed on the magnetism separation layer 16. Note that, the place of the first low-thermal expansion material layer 18 is not limited. Examples are shown in FIGS. 2A-16B.

The first low-thermal expansion material layer 18 is composed of the insulating material. Preferably, a thermal expansion coefficient of the insulating material is smaller than that of Al₂O₃. For example, the insulating material may be composed of SiC, Si₃N₄, SiO₂, AlN, Al₃S₄ or W.

By forming the first low-thermal expansion material layer 18, projecting a part of the magnetic head, especially a metallic part of the magnetic head, toward a magnetic storage medium, which is caused by increasing environmental temperature, can be prevented. In case that a projection length of the magnetic head is actually controlled by using a DFH heater (not shown), a standard position for measuring the projection length can be fixed, so that the projection length can be highly accurately controlled.

In the present embodiment, the lower magnetic pole (return yoke) 19 formed on the first low-thermal expansion material layer 18 is composed of a soft magnetic material, e.g., NiFe.

In the present embodiment, ground terminal sections 3a and lead terminal sections 3b are formed. Note that, sections of the ground terminal sections 3a are shown in FIG. 1B, but the lead terminal sections 3b have the same structure.

Each of the terminal sections 3a and 3b has a multilayer structure including a second low-thermal expansion material layer 28, which is composed of the insulating material as well as the first low-thermal expansion material layer 18, and a plurality of electrically conductive layers. In each of the ground terminal sections 3a, as shown in FIG. 1B, the second low-thermal expansion material layer 28 coats a part of a first conductive layer 25, and a second conductive layer 29 coats a part of the second low-thermal expansion material layer 28 and a part of the first conductive layer 25. A symbol 31 stands for an electrically conductive layer, and a symbol 41 stands for an electrically conductive layer for mutually connecting the ground terminal sections 3a.

The lead terminal sections 3b have the same structure, but a function of the lead terminal sections 3b is different from that of the ground terminal sections 3a. Thus, the ground terminal sections 3a and the lead terminal sections 3b are connected to different layers under the first conductive layer 25. Note that, a symbol 42 stands for a resistance connected to the ground terminal section 3a and the lead terminal section 3b.

In the magnetic head 1 having the first low-thermal expansion material layer 18, when the lower magnetic pole (return yoke) layer 19 is flattened, an exposed wafer surface 7 can be flattened without forming the raising layers 120 of the conventional magnetic head, which are additionally formed at the positions where the first low-thermal expansion material layer 118 is not formed.

In comparison with FIGS. 17A and 17B, the step of forming the raising layers 120 can be omitted in the present embodiment, so that a process time and a production cost can be reduced.

As shown in FIG. 1B, the magnetic head 1 of the present embodiment is characterized in that a lower surface area of the second low-thermal expansion material layer 28 of each of the terminal sections 3a and 3b is smaller than an upper surface area of the first conductive layer 25 thereof.

With this structure, the second conductive layer 29, which is formed on the second low-thermal expansion material layer 28, can be electrically connected to the first conductive layer 25, which is formed below the second low-thermal expansion material layer 28, and can be exposed as a wiring pattern after completing the step of flattening the lower magnetic pole (return yoke) layer 19.

A modified example of the first embodiment is shown in FIGS. 2A and 2B. Each of the second conductive layers 29 coats the second low-thermal expansion material layer 28 and is connected to the first conductive layer 25. In FIG. 1B, the connection is performed on the air bearing face side and the opposite side. On the other hand, in FIG. 2B, the connection is performed on the air bearing face side or the opposite side.

In this modified example, a lower surface area of the second low-thermal expansion material layer 28 of each of the terminal sections 3a and 3b is equal to or larger than an upper surface area of the first conductive layer 25, which is formed below the second low-thermal expansion material layer 28.

Further, another modified example is shown in FIGS. 3A and 3B. In this example too, a lower surface area of the second low-thermal expansion material layer 28 of each of the terminal sections 3a and 3b is equal to or larger than an upper surface area of the first conductive layer 25. The first low-thermal expansion material layer 18 and the second low-thermal expansion material layer 28 are integrally formed.

Another characteristic point of the present embodiment is an upper end part 28a of the second low-thermal expansion material layer 28 of each of the terminal sections 3a and 3b, which is formed into a tapered shape. Namely, parts 28b and 28c shown in FIG. 1B, a part 28b shown in FIG. 2B and a part 28c shown in FIG. 3B are formed into the tapered shapes.

Therefore, in case of forming the second conductive layer 29 on the second low-thermal expansion material layers 28 by plating, coverage of a metal film, which acts as a plating base, can be improved in the end parts 28b and 28c, so that the second conductive layer 29 can be stably formed by plating.

In case of forming the second conductive layer 29 by sputtering too, the second low-thermal expansion material layers 28 having enough thickness can be stably formed on the end parts 28b and 28c.

Further, insulating layers may be employed instead of the first low-thermal expansion material layer 18 and the second low-thermal expansion material layers 28 as a modified example of the first embodiment.

### SECOND EMBODIMENT

A second embodiment will be explained with reference to FIGS. 4A and 4B.

The present embodiment is characterized by a low-thermal expansion material layer 17 composed of an electrically conductive material. Concretely, the magnetic head 1 comprises: the magnetoresistance effect element section 14 being provided between the upper shielding layer 15 and the lower shielding layer 13 as an inner layer of a multilayer structure; a magnetic pole 19; the terminal sections 3a and 3b mutually electrically connecting the layers of the multilayer structure; and the low-thermal expansion material layer 17 composed of the electrically conductive material. Each of the terminal sections 3a and 3b has a multilayer structure including: a layer 27 composed of a material which is the same as that of the low-thermal expansion material layer 17; and electrically conductive layers 25 and 29.

With this structure, the second conductive layers 29 need not be directly connected to the first conductive layers 25. In the present embodiment too, the electrical interlayer connection via the layer 27 composed of the electrically conductive material can be performed as well as the first embodiment. Therefore, the production steps can be simplified.

For example, the electrically conductive material may include an electrically conductive matter, e.g., Si, C.

### THIRD TO SEVENTH EMBODIMENTS

Successively, third to seventh embodiments, in each of which the insulating low-thermal expansion material layer (the first low-thermal expansion material layer) 18 is formed, will be explained with reference to FIGS. 5A-9B.

In the third embodiment shown in FIGS. 5A and 5B, the first low-thermal expansion material layer 18 is formed immediately below the lower shielding layer 13.

In the fourth embodiment shown in FIGS. 6A and 6B, the first low-thermal expansion material layer 18 is formed between a first undercoat film 12a and a second undercoat film 12b.

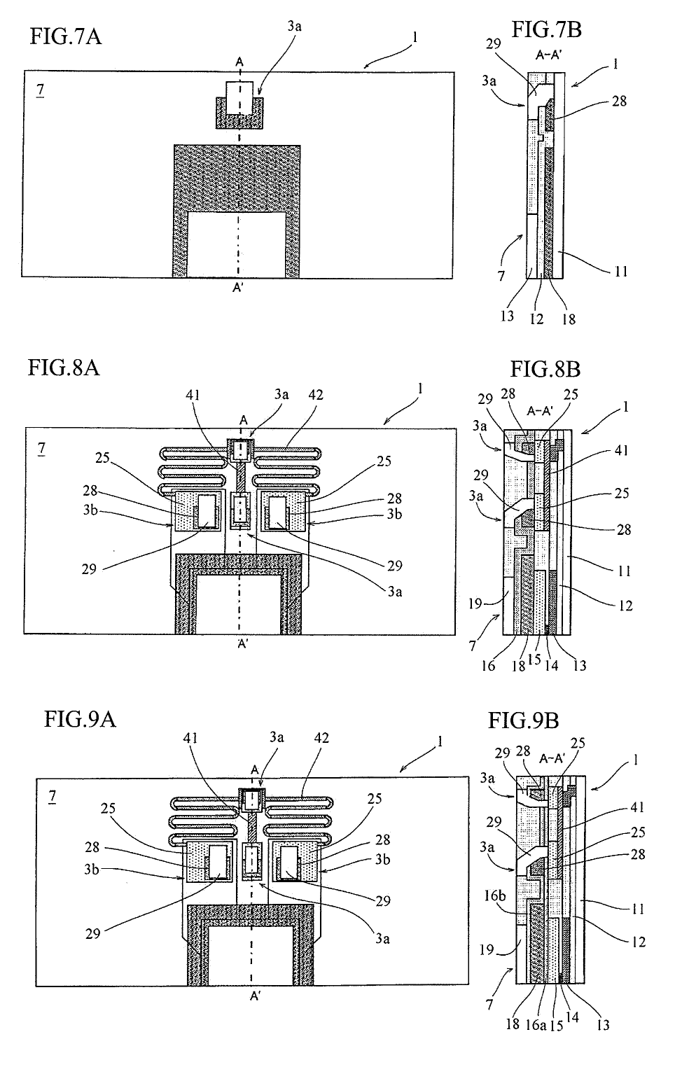

In the fifth embodiment shown in FIGS. 7A and 7B, the first low-thermal expansion material layer 18 is formed immediately below the undercoat film 12.

In the sixth embodiment shown in FIGS. 8A and 8B, the first low-thermal expansion material layer 18 is formed immediately below the upper shielding layer 15.

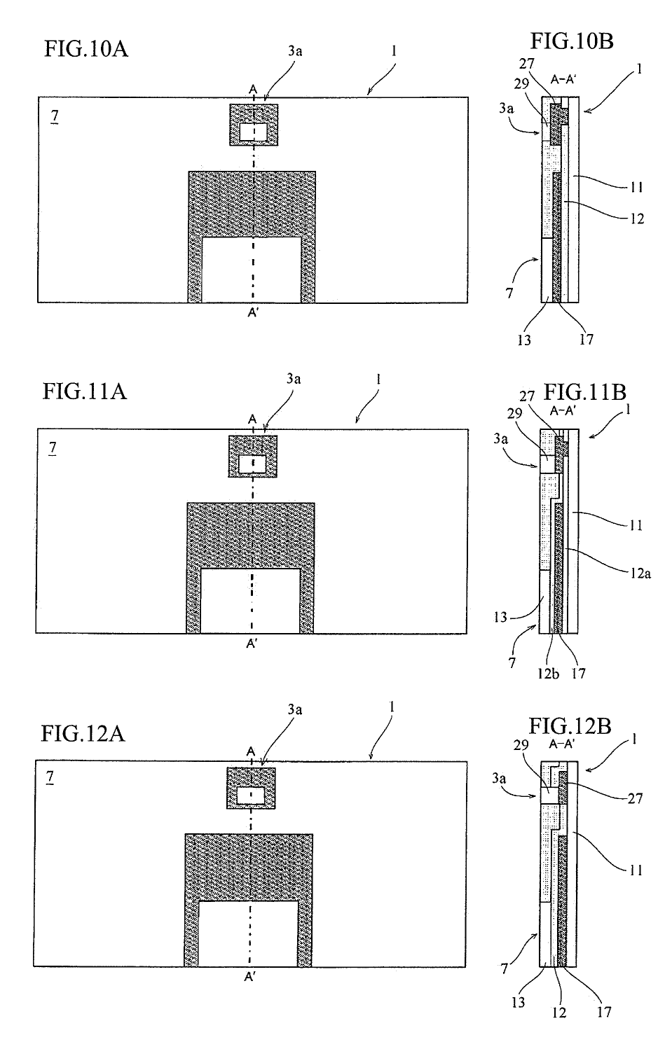

In the seventh embodiment shown in FIGS. 9A and 9B, the first low-thermal expansion material layer 18 is formed between a first magnetism separation layer 16a and a second magnetism separation layer 16b.

### EIGHTH TO FOURTEENTH EMBODIMENTS

Further, eighth to fourteenth embodiments, in each of which the low-thermal expansion material layer 17 composed of the electrically conductive material is formed, will be explained with reference to FIGS. 10A-16B.

In the eighth embodiment shown in FIGS. 10A and 10B, the low-thermal expansion material layer 17 is formed immediately below the lower shielding layer 13.

In the ninth embodiment shown in FIGS. 11A and 11B, the low-thermal expansion material layer 17 is formed between the first undercoat film 12a and the second undercoat film 12b.

In the tenth embodiment shown in FIGS. 12A and 12B, the low-thermal expansion material layer 17 is formed immediately below the undercoat film 12.

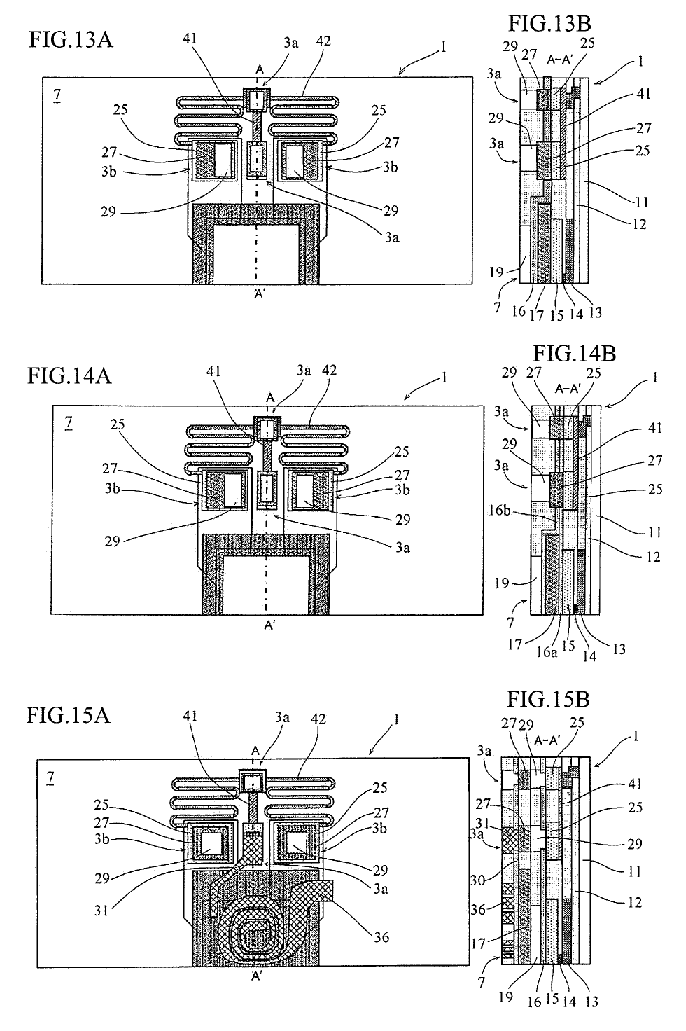

In the eleventh embodiment shown in FIGS. 13A and 13B, the low-thermal expansion material layer 17 is formed immediately below the upper shielding layer 15.

In the twelfth embodiment shown in FIGS. 14A and 14B, the low-thermal expansion material layer 17 is formed between the first magnetism separation layer 16a and the second magnetism separation layer 16b.

In the thirteenth embodiment shown in FIGS. 15A and 15B, the low-thermal expansion material layer 17 is formed immediately above the lower magnetic pole 19.

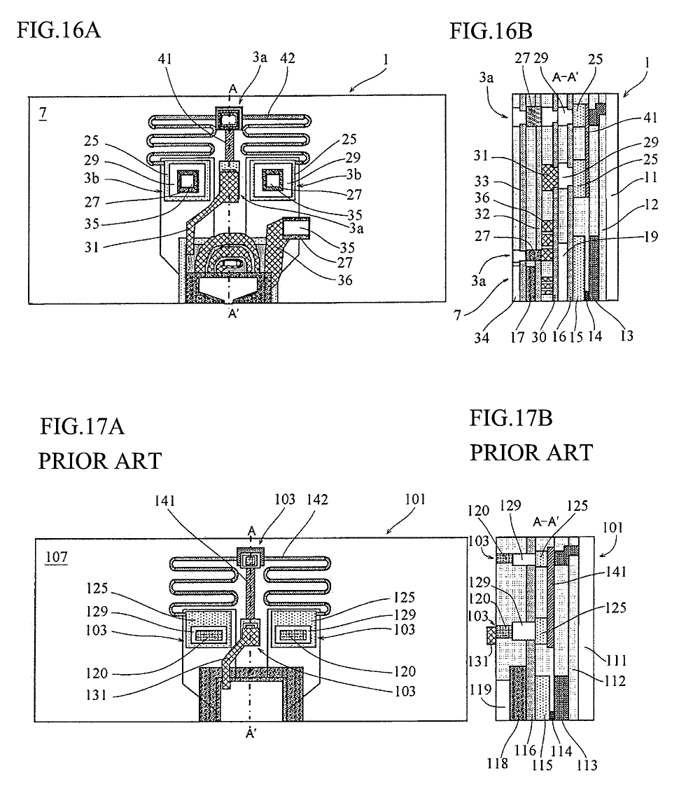

In the fourteenth embodiment shown in FIGS. 16A and 16B, the low-thermal expansion material layer 17 is formed immediately below a main magnetic pole layer 34. Note that, a symbol 35 stands for an electrically conductive layer, which is simultaneously formed when the main magnetic pole layer 34 is formed.

In each of the first to the fourteenth embodiments, projecting the periphery of the low-thermal expansion material layer 17 or the first low-thermal expansion material layer 18 toward the air bearing surface can be highly prevented. Note that, as shown in FIGS. 1A and 1B and FIGS. 4A and 4B, the low-thermal expansion material layer 17 or the first low-thermal expansion material layer 18 is formed between a reproducing element section and a recording element section, so that projecting the both element sections can be effectively prevented.

The magnetic heads including the low-thermal expansion material layers have been explained in the above described embodiments, but the present invention is not limited to the embodiments. The present invention can be applied to magnetic heads including insulating layers, multilayered circuits having similar structures, etc.

Namely, the multilayered circuit of the present invention, which has a multilayer structure, comprises: an element section which is an inner layer of the multilayer structure; terminal sections mutually electrically connecting layers of the multilayer structure; and a first insulating layer. Each of the terminal sections has a multilayer structure including: a second insulating layer composed of a material which is the same as that of the first insulating layer; and a plurality of electrically conductive layers including first conductive layers and second conductive layers. With this structure, the step of forming the raising layers can be omitted, so that the production steps can be simplified, and a process time can be shortened.

Further, in the multilayered circuit, a lower surface area of the second insulating layer of each of the terminal sections may be smaller than an upper surface area of the first conductive layer of each of the terminal sections, and an upper end part of the second insulating layer of each of the terminal sections may be formed into a tapered shape. With these structures, the effects explained in the first embodiment can be obtained in the multilayered circuit.

In the magnetic head and the multilayered circuit of the present invention, as described above, the low-thermal expansion layer or the insulating layer is formed as the inner layer of the multilayer structure, and the step of forming the raising layers can be omitted. Therefore, the production steps can be simplified, and the production cost can be reduced.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A magnetic head having a multilayer structure, comprising:
an upper shielding layer;
a lower shielding layer;
a magnetoresistance effect element section being provided between the upper shielding layer and the lower shielding layer as an inner layer of the multilayer structure;
a magnetic pole;
terminal sections mutually electrically connecting layers of the multilayer structure; and
a first low-thermal expansion material layer composed of an insulating material,
wherein each of the terminal sections has a multilayer structure including:
a second low-thermal expansion material layer composed of a material which is the same as that of the first low-thermal expansion material layer; and
a plurality of electrically conductive layers including first conductive layers and second conductive layers.

2. The magnetic head according to claim 1,
wherein the second low-thermal expansion material layer of each of the terminal sections coats a part of each of the first conductive layers, and
each of the second conductive layers coats a part of the second low-thermal expansion material layer of each of the terminal sections and a part of each of the first conductive layers.

3. The magnetic head according to claim 2,
wherein a lower surface area of the second low-thermal expansion material layer of each of the terminal sections is smaller than an upper surface area of the first conductive layer of each of the terminal sections.

4. The magnetic head according to claim 1,
wherein an upper end part of the second low-thermal expansion material layer of each of the terminal sections is formed into a tapered shape.

5. A magnetic head having a multilayer structure, comprising:
an upper shielding layer;
a lower shielding layer;
a magnetoresistance effect element section being provided between the upper shielding layer and the lower shielding layer as an inner layer of the multilayer structure;
a magnetic pole;
terminal sections mutually electrically connecting layers of the multilayer structure; and
a low-thermal expansion material layer,
wherein the low-thermal expansion material layer is composed of an electrically conductive material, and
each of the terminal sections has a multilayer structure including:
a layer composed of a material which is the same as that of the low-thermal expansion material layer; and
an electrically conductive layer.

6. A multilayered circuit having a multilayer structure, comprising:
an element section which is an inner layer of the multilayer structure;
terminal sections mutually electrically connecting layers of the multilayer structure; and
a first insulating layer,
wherein each of the terminal sections has a multilayer structure including: a second insulating layer composed of a material which is the same as that of the first insulating layer; and a plurality of electrically conductive layers including first conductive layers and second conductive layers,
the second insulating layer of each of the terminal sections coats a part of each of the first conductive layers, and
each of the second conductive layers coats a part of the second insulating layer of each of the terminal sections and a part of each of the first conductive layers.

7. The multilayered circuit according to claim 6,
wherein a lower surface area of the second insulating layer of each of the terminal sections is smaller than an upper surface area of the first conductive layer of each of the terminal sections.

8. The multilayered circuit according to claim 6,
wherein an upper end part of the second insulating layer of each of the terminal sections is formed into a tapered shape.
